(19) United States
(12) Patent Application Publication
(10) Pub. No.: US 2016/0048027 A1
(43) Pub. Date: Feb. 18, 2016

(54) VIRTUAL REALITY EXPERIENCE TIED TO INCIDENTAL ACCELERATION

(71) Applicant: Sam Shpigelman, San Diego, CA (US)

(72) Inventor: Sam Shpigelman, San Diego, CA (US)

(21) Appl. No.: 14/829,266

(22) Filed: Aug. 18, 2015

Related U.S. Application Data
(60) Provisional application No. 62/038,764, filed on Aug. 18, 2014.

(51) Int. Cl. G02B 27/01; G02B 27/00; G06F 3/0346; G06T 19/00

(52) U.S. Cl. CPC G02B 27/0179; G02B 27/017; G06T 19/006; G02B 27/0093; G06F 3/0346; G02B 2027/0178; G02B 2027/0187

(57) ABSTRACT

Incidental acceleration is used to provide an entertainment experience, where incidental acceleration is defined in one sense as acceleration that is not controlled by a user, that is in many cases present because of the user's presence in a traveling vehicle, such as an airplane, train, or car. Such may be employed to significantly improve the user's traveling experience, particularly where the user is wearing virtual reality goggles or the like, because the user will be less aware of the confined nature of the vehicle, and significantly more aware of the virtual reality environment. In a specific example, for travelers with a “fear of flying” or motion sickness, such systems and methods could lead to a more pleasurable flying experience. The acceleration data can be sourced from sensors associated with the vehicle or from a local source.

### CROSS-REFERENCE TO RELATED APPLICATIONS

This application claims benefit and priority of U.S. Provisional Application Ser. No. 62/038,764 filed Aug. 18, 2014, entitled “VIRTUAL REALITY EXPERIENCE TIED TO INCIDENTAL ACCELERATION” which is incorporated herein by reference in its entirety.

### BACKGROUND

It is known to traverse game or other online environments using, e.g., WASD keys, game controllers, or joystick controls.

Certain types of accelerometer control are also known, such as to drive a virtual car or fly a virtual airplane using an installed accelerometer on a tablet computer, e.g., to bank left or right by tilting the tablet computer to the left or to the right. But these experiences are driven by the player, who controls the orientation of the tablet computer and who desires that, in this example, the airplane bank to the left or right.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

In systems and methods according to present principles, incidental (or even “accidental”) acceleration is used to provide an entirely new type of entertainment experience, where incidental acceleration is defined as (in a nonlimiting sense) acceleration that is not controlled by a user, that is in many cases present because of the user's presence in a traveling vehicle, such as an airplane, train, or car.

Such may be employed to significantly improve the user's traveling experience, particularly where the user is wearing virtual reality goggles or the like, because the user will be less aware of the confined nature of the vehicle, and significantly more aware of the virtual reality environment. In a specific example, for travelers with a “fear of flying”, such systems and methods could lead to a more pleasurable flying experience. The same could make car rides more interesting for passengers, and allow the same to seem to desirably pass more quickly. In certain implementations, the virtual reality environment may be modified with the acceleration data to not just provide the entertainment experience but also to mollify or otherwise reduce the effects of nausea due to motion sickness.

The acceleration data can be sourced from sensors associated with the vehicle or from a local source, e.g., an accelerometer associated with a local tablet computer, mobile device such as a smart phone, smart watch, smart eye wear, or the like. In some cases the accelerometer data may be deduced or calculated from other sources, such as velocity or location data, the location data from, e.g., GPS data. If the computer running the simulation or online environment is associated with the user, and not the airliner, e.g., a local laptop brought by the user, then generally acceleration information must be sourced locally, as such information is generally not available from the cockpit instrumentation. In these implementations, effects of local acceleration can be approximately simulated in the online environment, though the result may not be as exact as it airplane sensors were employed. However, where the airliner operates one or several servers in turn operating online environments, then acceleration (and other data such as altitude or location data) may be sourced from the cockpit instrumentation or airplane sensors.

The server can be any computer capable of performing the necessary calculations and rendering (either by itself or with a graphics card or integrated graphics chipset) the requisite virtual reality display (in some cases, the acceleration data may be received from the vehicle and rendered directly in the VR headset). In one implementation, a commercial airliner has several servers on board, each server running a different virtual reality environment. Users may take part in a selected one of the environments, and all users selecting a given environment are together on the server associated with and running that environment. User profiles or settings may be employed to determine whether an avatar of the user is employed, and whether the avatar can be seen by the user or other users, the appearance of the avatar, privacy settings, difficulty settings where there are game components, a location within the virtual environment, and so on.

The virtual reality environment can be selected from virtual reality goggles, eye wear configured for augmented reality uses, or even in some cases a laptop or tablet display, although it will be understood that the virtual reality experience tends to be lesser in such devices. Other such displays may include touchscreen displays, especially where the same are already present in a vehicle, such as on commercial airliners.

In the simulation, actual or approximated acceleration data can be used as “incidental acceleration data” to mimic the effect of the acceleration on the user's movement in the virtual world, as if it was the user (or user's avatar) that experienced the accceleration, rather than (or in addition to) the airplane. In this way, turbulence or other acceleration experienced in an aircraft can be transformed into an entertainment experience, at least temporarily to some extent taking the passenger's mind off the turbulence and advantageously giving a context to the acceleration other than a plane passing through turbulence.

For example, the user's avatar could be a person on a horse, and upon changes in altitude the horse could be made to appear to climb a hill (increases in altitude) or race down the hill (decreases in altitude) or jump an obstacle (if the airplane hit an air pocket). Clearly (given this disclosure) the user may be provided with, and be allowed to select from, numerous other experiences, e.g., riding a bird, a fish, running an obstacle course, or the like. For example, if the participant chooses to experience a simulation as a fish, a bird, a dragon, or a horse, then the First Person POV will be set to represent a vision of the corresponding animal.

In more abstract environments, the importance of self (the avatar) may become less important, so the POV will be representing a First Person POV of an abstract entity. For example, a POV of a photon traveling at light speed through a Universe, or a musical note traveling through a world of music/sound waves. Other environments, realistic and abstract, will be understood, given this disclosure.

The visual effects (or other changes in virtual reality environment, e.g., a change in view or perspective, a change in size, a change in viewed environment, or any other such change) may be generally tied to acceleration, so as to enhance the user's visual experience with corresponding acceleration data. For example, similar such analogs may be had such that the avatar is riding a skateboard or other device, or where the avatar is in a boat jumping waves. This latter analog, taking place in a water environment, may be extended to 4D environments where a slight spray or mist of water may impact against the user, thereby heightening the immersion and virtual reality experience. It will be clear given this teaching that the 4D environment may be extended to wind effects, smells, and the like.

As noted, an airliner may have several environments running at the same time, each on a different (or the same) server. The scenery may be pre-generated or dynamically generated, and traversing the environment may be timed to coincide approximately with the flying time. Scenery effects may be generated on-the-fly, with particular scenery effects generated due to the incidental acceleration. Users may participate in the simulation for the entire flight, or may enter the simulation at any time during the flight. The user may choose to enter the simulation at the beginning of the simulation, or at the current location in the simulation (on the timeline), or at any other point. That is, in some implementations, participants may be enabled to enter the virtual world experience at any time during the travel, e.g., may be able to choose the point of entry anywhere from the beginning of the simulation to the current time of the simulation.

The users may encounter and traverse the environment at different speeds according to their liking, or at speeds of traversal set by the environment.

In one aspect, the invention is directed towards a non-transitory computer-readable medium, including instructions for causing a computing environment to perform a method of operating a virtual reality environment, the method including: operating a virtual reality environment and rendering a view for a user of the virtual reality environment, the rendering appropriate for a binocular display; receiving a signal corresponding to an incidental acceleration; and changing the virtual reality environment and/or generating a visual effect in the virtual reality environment based on the received signal corresponding to an incidental acceleration, and rendering the visual effect in a way appropriate for a binocular display.

Implementations of the invention may include one or more of the following. The method may further include: receiving a signal corresponding to a user generated acceleration; and combining the signal corresponding to a user generated acceleration with the signal corresponding to an incidental acceleration, where the changes in the virtual reality environment and/or the visual effect are generated based on the combined signal. The virtual reality environment may be one of a plurality of virtual reality environments operated on board a vehicle for the benefit of a plurality of passengers, and the method may further include receiving a selection from a passenger of a virtual reality environment to experience. The incidental acceleration may be received from an accelerometer associated with a mobile device. The mobile device may be a laptop, tablet, VR goggles or headset, or smart phone. The incidental acceleration may be received from an accelerometer associated with a vehicle. The vehicle may be an airplane, a train, a bus, or an automobile.

The changing virtual reality environment and/or generated visual effect or/and visual effect may be configured to mimic an effect of the incidental acceleration on the VR environment. The method may further include causing a 4D effect within the VR environment based on the incidental acceleration. The incidental acceleration may be calculated by determining a total acceleration and a head acceleration and subtracting the head acceleration from the total acceleration. The incidental acceleration may be the only input driving changes in the virtual reality environment. The incidental acceleration may drive changes in the virtual reality environment and the measured head acceleration may drive a user capability to rotate their head and see corresponding changes in the virtual reality environment. The incidental acceleration may drive changes in the virtual reality environment caused by vehicle accelerations measured with respect to a fixed coordinate system, and the measured head acceleration may drive changes in the virtual reality environment caused by accelerations measured with respect to a moving coordinate system, the moving coordinate system moving along with the vehicle. The driven changes in the virtual reality environment may be configured to reduce the effect of motion sickness. For example, the driven changes in the virtual reality environment may be configured to maintain an apparent horizon line within the virtual reality display. The driven changes may maintain the apparent horizon line within the virtual reality display within plus or minus 45° from the horizontal.

In another aspect, the invention is directed towards a method of operating a virtual reality environment, including: operating a virtual reality environment and outputting a signal representing a view of the virtual reality environment; receiving a signal corresponding to an incidental acceleration; and generating a change in the virtual reality environment and/or generating a visual effect in the virtual reality environment based on the received signal corresponding to an incidental acceleration, and changing the virtual reality or adding a visual effect to the view corresponding to the incidental acceleration.

In yet another aspect, the invention is directed towards a non-transitory computer-readable medium, including instructions for causing a computing environment to perform the above method.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a schematic diagram of the system according to present principles.

FIG. 2 is a flowchart illustrating a method according to present principles.

FIG. 3 is a diagram illustrating a fixed reference frame and a moving reference frame. While the moving reference frame is shown with a velocity vector, it is understood that the moving reference frame may also have accelerations acting on the same.

FIG. 4 illustrates a VR display (just one eye is shown) in which an apparent horizon line is maintained within an envelope to ease the effects of nausea due to motion sickness.

Like reference numerals refer to like elements throughout. Elements are not to scale unless otherwise noted.

### DETAILED DESCRIPTION

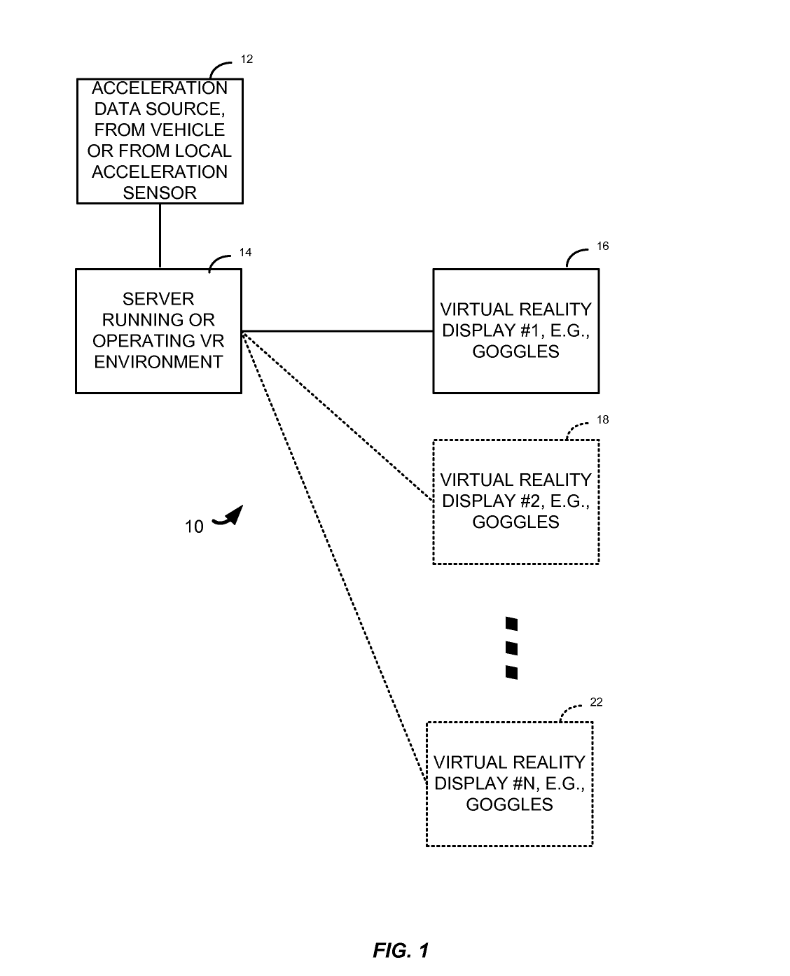

In a particular implementation, as seen by the system 10 of FIG. 1, a server 14 runs or operates a virtual reality environment. The server 14 receives acceleration data from an acceleration data source, such as a vehicle operating environment, or from a local acceleration sensor such as on a smart phone laptop. The acceleration data may also be deduced from other sources, e.g., location data (by taking a second derivative with respect to time), as such location data may be available in certain VR environments. The server running the VR environment sends display signals to a virtual reality display 16. The signals can be a rendering of the environment, or the rendering can occur within the virtual reality display. And as noted above, in some cases the VR headset itself may download and run applications, including rendering routines, so the entire virtual environment may be calculated within the headset. A number of virtual reality displays 18-22 are also shown, which may simulate the case of an airliner (or other vehicle including a cruise ship or bus) operating an environment on a server 14 and serving a number of passengers.

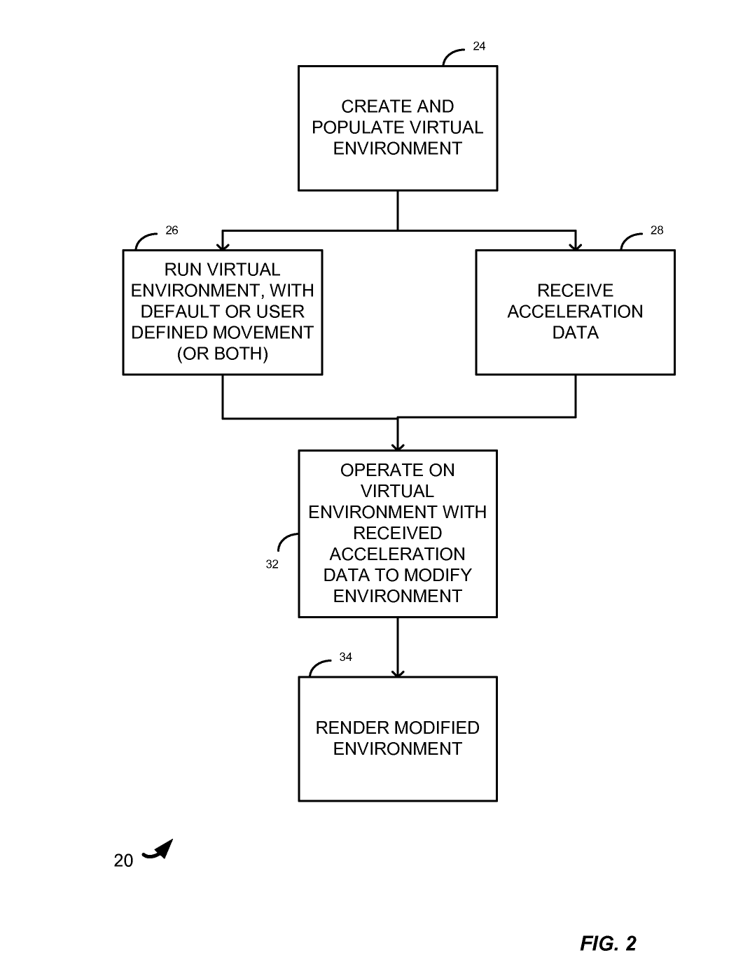

FIG. 2 shows a flowchart 20 of a method according to present principles. In a first step, a virtual environment is created and populated (step 24). The virtual reality environment is then run or otherwise instantiated and operated (step 26). The virtual environment can allow a default user movement (which can be no user movement), or the same can be entirely determined by motion of the underlying vehicle. Users may also be enabled to control their movement such as by a joystick, game controller, using WASD keys, a wearable interface, or the like. These various movements may be overlaid or superposed on top of each other as well. Acceleration data is received by the system (step 28), and the virtual environment is operated on with the received acceleration data to modify the environment. The received acceleration data is deemed the incidental acceleration, and the incidental acceleration may cause various effects in the virtual environment, such as visual effects, scenery changes, triggers for various motions analogous to the acceleration, or the like. The modified environment is then rendered (step 34) and transmitted to the virtual reality display.

The systems and methods according to present principles may be advantageously employed to, in some implementations, change potentially negative experiences to positive and exciting ones, e.g.:

| NEGATIVE | |
|---|---|
| EXPERIENCE | POSITIVE EXPERIENCE |
| Turbulence, air pockets, | Visual effects, dynamic level generation or |
| shaking, banking | adjustment, dynamic participant's control |
| Fear of flying | Simulation taking participant's mind away |
| | from flying experience |
| Claustrophobia | Provided by a simulation, participant's |
| | experience may be adjusted to a wide-open |
| | space |
| Impatience/boredom | Virtual experience will provide variety of |
| especially in case of | visual stimulation to keep participants |
| children | engaged |
| Isolation | Participants may choose to experience a |
| | virtual simulation alone or via an in-group |
| | environment with virtual AI or virtual |
| | participants |

Such systems and methods may provide numerous experiences for many purposes including (but not limited to) the following (in which accidental acceleration data may or may not be employed):
a. Entertainment (experience movie watching, pre-recorded or live performance, book reading, etc., in fabricated virtual locations or locations that were created to mimic real world architectural structures)
b. Meditation (virtual location to promote peaceful setting for meditation)
c. Exploration/Information (infomercial to promote specific destinations, attractions, and services)
d. Education (factual programming to promote learning)
e. Gaming (interactive virtual environments with meaningful play elements with or without accidental acceleration data)

A personal VR headset may also be connected to a vehicle or craft input/output I/O interface or data may be entered by a staff of the vehicle or craft. Numerous interfaces will be understood.

In one implementation, and as noted above, the acceleration signal does not come from an acceleration sensor mechanically coupled to the headset. In other words, an acceleration sensor (accelerometer) associated with and measuring the acceleration the vehicle undergoes is used to provide an acceleration signal and value/vector. For example, in most cases the acceleration signal used by a VR headset in calculating changes to the display is:

a_{TOTAL}=a_{HEAD}+a_{USER'S BODY}=a_{HEAD}+a_{UB}

In prior efforts, a_{UB} is usually considered to be zero or negligible, and so:

a_{TOT}=a_{HEAD}

In systems and methods according to certain implementations of present principles, however, a_{UB} is used to drive the experience.

So, in one specific implementation, the same may be decoupled by subtracting out the head movement:

a_{UB}=a_{TOT}−a_{HEAD}

In this specific implementation, user had movements do not count towards the VR experience. The same is driven only by the vehicle acceleration a_{UB}.

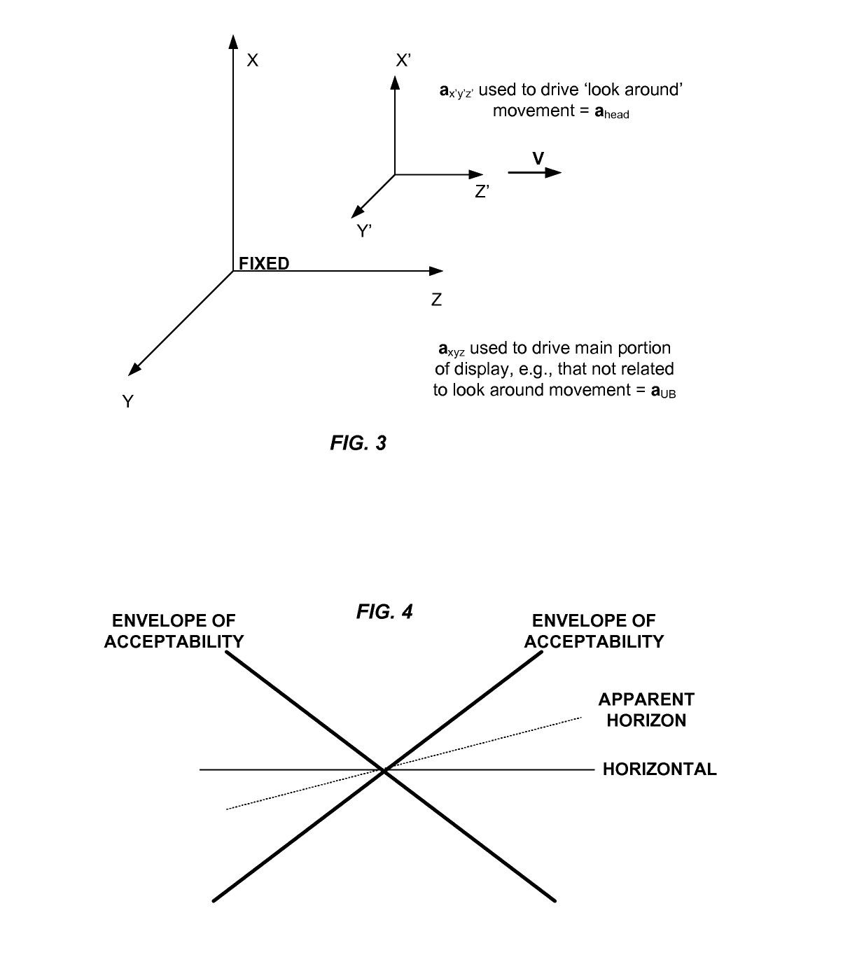

In another specific implementation, both accelerations are employed. a_{UB} is used to provide a VR experience including providing the signal for changes to the display of the VR headset, e.g., often large-scale changes related to the movement of the user in the vehicle, and what has been termed above “incidental” or “accidental” acceleration. The a_{HEAD} signal is used to provide local motion, e.g., changes in the display caused by local accelerations and movement, where ‘local’ is defined with respect to the moving frame of reference, e.g., the frame of reference moving along with the vehicle. These local motion changes are generally smaller scale changes, related to allowing the user to look around their environment, i.e., the environment through which they are moving. See, e.g., FIG. 3. a_{head} is used to solely drive “look around” movement, not translational movement. In this embodiment, the user is “allowed” or “enabled” to look around their environment, but the looking around only affects the local (moving) reference frame, not the VR experience with respect to the overall movement with respect to the stationary or fixed frame of reference.

As a specific example, in a VR experience enjoyed by the user during an airplane ride, turbulence encountered is specific to the vehicle, not user had movement, and thus would constitute incidental or accidental acceleration, termed here a_{UB}. This may drive a portion of the VR display, e.g., the user VR display may show that the user (or an avatar or point of view POV) is on a horse galloping or perhaps jumping over an obstacle. a_{head} is not used for such display in this embodiment. Rather, a_{head} is used to enable the user to look around their environment as the galloping is occurring.

To summarize the above specific implementation, linear accelerations from a_{UB} may be used to drive a portion of the VR experience, and in particular portions of the display related to incidental or accidental acceleration. Rotational accelerations from a_{head} may also be used to drive a portion of the VR experience, and in particular the look around ability. Rotational accelerations from a_{UB} may be ignored, or in some cases may also be used to drive a portion of the VR experience, and in particular portions of the display related to incidental or accidental acceleration. Linear accelerations from a_{head} may be ignored, or alternatively employed to provide an even more enhanced look around capability. It is noted that, in this regard, with appropriate configuration, both linear and rotational accelerations can be measured and independently determined.

The environmental acceleration data may not necessarily be provided by the instruments, which are built into an environment such as plane, train, car, etc. . . . . Rather, the same may be provided by a stand alone 3rd party device that is placed within the environment. For example, it can be portable and owned by individual users. In yet another implementation the VR simulation environments may be computed on user's portable devices in oppose to airline or other vehicle servers, etc. Such device may provide acceleration and/or positioning data of the environment separately from the instruments inside the head gear. Both data may be processed by the VR simulation software to provide desired effect. For example, to counter balance the effect of motion sickness, the VR simulation environment would adjust to provide a steady horizon line, or to provide desired visual context to sudden banking or elevation change in a plane. Other ways of counteracting or counter balancing motion sickness may also be employed given this disclosure. For example, and referring to FIG. 4, an envelope of acceptable apparent horizon lines may be defined, e.g., +/−45° from the horizontal, +/−30° from the horizontal, +/−10° from the horizontal, +/−5° from the horizontal, and variations, and the apparent horizon may be maintained visually within the VR headset within the acceptable envelope.

In another variation, the system can be capable of recognizing user's movement such as forward, backwards, side, up and down. This movement is different from user's head movement such as tilting and turning. If a significant amount of user movement is detected, a safety may be triggered to prevent the user from continuing viewing the virtual/augmented reality environment. This can be done in a form of pause, fade to black, white or any other color, warning sign or text, etc., in any combination. The system may then require user's input to resume the viewing experience. This aspect provides an important safety feature in that the user may be effectively prohibited from viewing while walking around. It is note that some AR/VR devices are capable of recording small directional movements due to user's leaning forward, backwards, side to side, up and down. Such movements should not stop the viewing experience. If the player stands up, starts walking, etc., on the other hand, these moves may generally pass a pre-defined movement threshold and the above mentioned safety mechanism may be triggered. Implementation of the safety mechanism may be via a number of techniques, including GPS, accelerometer, Bluetooth® (including by detecting if the user exceeds a certain distance away from a computer), and so on.

Certain details of systems and methods according to present principles are provided in Applicant's co-pending patent application Ser. No. 14/690,207, filed Apr. 17, 2015, entitled “System and Method for Augmented or Virtual Reality Entertainment Experience”, owned by the assignee of the present application and herein incorporated by reference in its entirety.

The system and method may be fully implemented in any number of computing devices. Typically, instructions are laid out on computer-readable media, generally non-transitory, and these instructions are sufficient to allow a processor in the computing device to implement the method of the invention. The non-transitory CRM in this case may be within a server on an airplane, within a laptop (or other computer or computing environment) running a VR application, within a VR, and so on. The content may also be streamed from a remote location. The computer-readable medium may be a hard drive or solid state storage having instructions that, when run, are loaded into random access memory. Inputs to the application, e.g., from the plurality of users or from any one user, may be by any number of appropriate computer input devices. For example, users may employ a keyboard, mouse, touchscreen, joystick, trackpad, game controller, wearable devices, other pointing device, or any other such computer input device to input data relevant to the calculations. Data may also be input by way of an inserted memory chip, hard drive, flash drives, flash memory, optical media, magnetic media, or any other type of file-storing medium. The outputs may be delivered to a user by way of a graphics processor, a video graphics card, or an integrated graphics chipset coupled to a display that maybe seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or WiFi-connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method. In the below system where incidental acceleration as an input to a virtual reality system is contemplated, the plural inputs may allow plural users or devices to input relevant data and inputs at the same time.

1. A non-transitory computer-readable medium, comprising instructions for causing a computing environment to perform a method of operating a virtual reality environment, the method comprising:
a. operating a virtual reality environment and rendering a view for a user of the virtual reality environment, the rendering appropriate for a binocular display;
b. receiving a signal corresponding to an incidental acceleration; and
c. changing the virtual reality environment and/or generating a visual effect in the virtual reality environment based on the received signal corresponding to an incidental acceleration, and rendering the visual effect in a way appropriate for a binocular display.

2. The medium of claim 1, further comprising:
a. receiving a signal corresponding to a user generated acceleration;
b. combining the signal corresponding to a user generated acceleration with the signal corresponding to an incidental acceleration; and
c. wherein the changes in the virtual reality environment and/or the visual effect are generated based on the combined signal.

3. The medium of claim 1, wherein the virtual reality environment is one of a plurality of virtual reality environments operated on board a vehicle for the benefit of a plurality of passengers, and further comprising receiving a selection from a passenger of a virtual reality environment to experience.

4. The medium of claim 1, wherein the incidental acceleration is received from an accelerometer associated with a mobile device.

5. The medium of claim 4, wherein the mobile device is a laptop, tablet, VR goggles or headset, or smart phone.

6. The medium of claim 1, wherein the incidental acceleration is received from an accelerometer associated with a vehicle.

7. The medium of claim 6, wherein the vehicle is an airplane, a train, a bus, or an automobile.

8. The medium of claim 1, wherein the changing virtual reality environment and/or generated visual effect are configured to mimic an effect of the incidental acceleration on the VR environment.

9. The medium of claim 1, further comprising causing a 4D effect within the VR environment based on the incidental acceleration.

10. The medium of claim 1, wherein the incidental acceleration is calculated by determining a total acceleration and a head acceleration and subtracting the head acceleration from the total acceleration.

11. The medium of claim 10, wherein the incidental acceleration is the only input driving changes in the virtual reality environment.

12. The medium of claim 1, wherein the incidental acceleration drives changes in the virtual reality environment and wherein measured head acceleration drives a user capability to rotate their head and see corresponding changes in the virtual reality environment.

13. The medium of claim 12, wherein the incidental acceleration drives changes in the virtual reality environment caused by vehicle accelerations measured with respect to a fixed coordinate system, and wherein the measured head acceleration drives changes in the virtual reality environment caused by accelerations measured with respect to a moving coordinate system, the moving coordinate system moving along with the vehicle.

14. The medium of claim 1, wherein the driven changes in the virtual reality environment are configured to reduce the effect of motion sickness.

15. The medium of claim 14, wherein the driven changes in the virtual reality environment are configured to maintain an apparent horizon line within the virtual reality display.

16. The medium of claim 15, wherein the driven changes maintain the apparent horizon line within the virtual reality display within a predetermined acceptable threshold from the horizontal.

17. A method of operating a virtual reality environment, comprising:
a. operating a virtual reality environment and outputting a signal representing a view of the virtual reality environment;
b. receiving a signal corresponding to an incidental acceleration; and
c. generating a change in the virtual reality environment and/or generating a visual effect in the virtual reality environment based on the received signal corresponding to an incidental acceleration, and changing the virtual reality or adding a visual effect to the view corresponding to the incidental acceleration.

18. A non-transitory computer-readable medium, comprising instructions for causing a computing environment to perform the method of claim 17.
